(19) United States
(12) Patent Application Publication
(10) Pub. No.: US 2007/0244255 A1
(43) Pub. Date: Oct. 18, 2007

(54) Pressure sensitive adhesive and method for improving weatherability thereof

(75) Inventors: Shun-Cheng Wang, Taoyuan County (TW); Yi-Chih Chan, Taipei County (TW)

Correspondence Address: BIRCH STEWART KOLASCH & BIRCH, PO BOX 747, FALLS CHURCH, VA, 22040-0747, US

(73) Assignee: Daxon Technology Inc.

(21) Appl. No.: 11/455,097

(22) Filed: Jun. 19, 2006

(30) Foreign Application Priority Data
Apr. 13, 2006 (TW) 95113143

(51) Int. Cl. C09J 133/00; C08L 33/00; B32B 27/30

(52) U.S. Cl. 525/100; 525/107; 525/123; 156/327

(57) ABSTRACT

The invention provides a high weatherability pressure sensitive adhesive comprising an acrylic adhesive, a cross-linking agent and at least two different silane coupling agents. The weight ratio of the cross-link agent to the silane coupling agent is preferably about 0.1 to 0.4. The pressure sensitive adhesive can pass 500 hours weatherability test at conditions of 85° C./90% RH.

### BACKGROUND OF THE INVENTION

1. Field of the Invention

The invention relates to a pressure sensitive adhesive and in particular to a pressure sensitive adhesive comprising at least two different silane coupling agents.

2. Description of the Related Art

Pressure sensitive adhesives (PSA) can adhere to most surfaces with very slight pressure. Pressure sensitive adhesives are based on organic polymer. Unlike conventional adhesives, pressure sensitive adhesives are formed without severe solidification process, in a viscoelastic state. Generally, pressure sensitive adhesives comprise compositions of high elasticity and high viscosity in order to adhere to materials rapidly with very slight pressure and decrease residual adhesives upon removal.

Pressure sensitive adhesives have been applied widely in, for example, liquid crystal displays (LCD). A liquid crystal display comprises a liquid crystal layer interposed between two layers of glass. An optical film such as polarizer or phase reflective film adhered to the outer surface of the glass improves optical properties. Acrylic-based or epoxy resin-based pressure sensitive adhesive is commonly used to adhere the optical film to the glass.

Weatherability problems in the pressure sensitive adhesive coated on an optical film can cause curling, bubbling and peeling, under conditions of high temperature and high humidity. Furthermore, non-uniform distribution of tension on the optical film under such conditions may induce light leakage.

U.S. patent No. 20040152812 and JP patent No. JP2000109771 disclose some methods of solving the weatherability issues, but have failed to solve weatherability problems caused at more than 85° C. and light leakage of liquid crystal displays larger than 37 inch.

### BRIEF SUMMARY OF THE INVENTION

The invention provides a pressure sensitive adhesive, comprising an acrylic adhesive, a cross-linking agent and at least two different silane coupling agents.

The invention further provides a method for improving weatherability of pressure sensitive adhesive, comprising mixing a cross-linking agent, at least two different silane coupling agents and an acrylic adhesive.

A detailed description is given in the following.

### DETAILED DESCRIPTION OF INVENTION

The invention provides a high weatherability pressure sensitive adhesive and the fabricating method thereof to solve the problem of peeling, bubble and curl of conventional pressure sensitive adhesive induced under the conditions of high temperature and high humidity.

The pressure sensitive adhesive of the invention may be a conventional acrylic adhesive, preferably a polymer, which is formed by polymerizing 1-99 wt % alkyl acrylate, 1-20 wt % alkoxide monomer, such as hexyl group, heptyl group, cycol hexyl group, 2-ethyl hexyl group, iso-nonyl group or lauryl group, and 1-10 wt % hydroxyl-containing monomer, such as 2-hydroxyethyl methacrylate, 4-hydroxybutyl methacrylate, 6-hydroxyhexyl methacrylate, 8-hydroxyoctyl methacrylate, 10-hydroxydecyl methacrylate or 12-hydroxylauryl methacrylate, having a molecular weight of about 1100000 to 2000000. The pressure sensitive adhesive of the invention preferably comprises alkyl (meth)acrylate of at least more than 20 wt % with preferably more than six carbon atoms.

The pressure sensitive adhesive further comprises a cross-linking agent such as diisocyanate or epoxy resin, preferably diisocyanate. The suitable diisocyanates comprise toluene-2,4-diisocyanate, toluene-2,6-diisocyanate, diphenyl methane-4,4′-diisocyanate or 1,6-hexamethylene diisocyanate. The cross-linking agent is about 0.01-0.2 parts by weight based on 100 parts by weight of the acrylic adhesive.

The pressure sensitive adhesive of the invention further comprises at least two different silane coupling agents, including but not limited to methoxysilane, dimethyldimethoxysilane, methyltrimethoxysilane, methacryloxypropyltrimethoxysilane, methacryloxypropyltriethoxysilane, methyl(glycidoxypropyl)diethoxysilane, ethyltrimethoxysilane, vinyltrimethoxysilane, vinyltriacetoxysilane, Vinyltris(methoxyethoxy)silane, propyltrimethoxysilane, acryloxypropyltrimethoxysilane, aminosilane hydrochloride, aminoethylaminopropyltrimethoxysilane, aminopropyltrimethoxysilane, gamma-aminopropyltriethoxysilane, glycidoxypropyltrimethoxysilane, isobutyltrimethoxysilane, phenyltrimethoxysilane, phenylmethyldimethoxysilane, cyclohexyltrimethoxysilane, cyclohexyldimethoxymethylsilane or cyclopentyltrimethoxysilane, preferably SA-1(produced by Soken) having solid content of 50%, SA-2 (produced by Dow corning) having solid content of 7-12% and SA-3 (produced by Dow coming) having solid content of 8-15%. When 0.02 parts by weight of the cross-linking agent, the two different silane coupling agents preferably have a weight ratio of about 5:1, and more preferably 1:1.

Weatherability of the pressure sensitive adhesive can be improved by adding at least two different silane coupling agents thereto and adjusting the weight ratio of the cross-linking agent to the silane coupling agent. Although the adhesion between a glass and pressure sensitive adhesive can be increased with the increase of silane coupling agent in pressure sensitive adhesive, there are side effects such as bubble and peeling induced therebetween with excess silane coupling agent. According to experimental results, the weight ratio of cross-linking agent to silane coupling agent is optimal between 0.1 and 0.4, more preferably between 0.15 and 0.3. If the weight ratio of cross-linking agent to silane coupling agent is more than about 0.4, bubbling and peeling is induced. Weatherability of pressure sensitive adhesive can also be improved by adding more than two different silane coupling agents.

### EXAMPLES AND COMPARATIVE EXAMPLES

### Example 1

A. Preparation of pressure sensitive adhesive: isocyanate and silane coupling agent, diluted ten to twenty times with ethyl acetate, were added to acrylic adhesive (100 g), wherein the weight of isocyanate or silane coupling agent is product of dilated weight multiplying of dilution ratio. For example, 0.5 parts by weight of isocyanate was dilated to 20 parts by weight with ethyl acetate. 0.8 parts by weight of Diluted isocyanate was mixed with acrylic adhesive uniformly and was left standing for thirty minutes to remove bubbles therefrom.

B. Preparation of polarizer: PET (Poly(ethylene terephthalate)) having a thickness of about 38 μm with a release film thereon was coated with pressure sensitive adhesive prepared in step A at thickness of about 25 μm by hand, and heated at 90A for five minutes. A three-layered structure having polarizer film (Polyvinyl Alcohol, PVA) and support films (super wide view triacetyl cellulose, SWV-TAC and triacetyl cellulose, TAC) on both sides of PVA was provided. The pressure sensitive adhesive-coated PET was bound to the support film (SWV-TAC), and then aged at 35° C./65% RH for 7˜10 days.

C. Preparation of weatherability test sample: the aged polarizer was cut to 100 mm×100 mm, and bound to an alkaline glass after removal of the release film by adhesive tape. The polarizer was placed in a temperature and humidity chamber for weatherability testing at 85° C./90% RH.

Table 1 shows the comparison of weatherability testing results between pressure sensitive adhesives with one kind of silane coupling agent and with two different silane coupling agents at 85° C./90% RH. It is noted that the pressure sensitive adhesive with two different silane coupling agents, SA-1 and SA-2, shows no peeling under test conditions for 500 hours.

Table 2 shows ratio effect of isocyanate to silane coupling agent (I/S) for peeling. It is known that the pressure sensitive adhesive with two different silane coupling agents, SA-1 and SA-2, having mixture ratio of about 1:1 and with I/S ratio of about 0.17 shows no peeling under test conditions for 500 hours.

TABLE 1

| | | | I/S | under test conditions |
|---|---|---|---|---|
| example | Silane coupling agent | | ratio | for 500 hours |
| 1 | SA-1 | — | 0.17 | peelings |
| 2 | SA-1 | SA-2 | 0.17 | No peelings |
| 3 | SA-1 | — | 0.24 | Peelings and bubbles |
| 4 | SA-1 | — | 0.62 | Peelings and bubles |
| 5 | SA-1 | — | 0.97 | peelings |

TABLE 2

| | Weight of additives | | | Ratio of | | |
|---|---|---|---|---|---|---|
| | isocyanate | | | mixing | | |
| | (cross- | | | silane | | Mean Time |
| | linking | | | coupling | I/S | to Failure |
| example | agent) | SA-1 | SA-2 | agents | ratio | (MTTF) |
| 6 | 0.02 g | 0.059 g | 0.059 g | 1:1 | 0.17 | 526 hr |
| 7 | 0.03 g | 0.06 g | 0.06 g | 1:1 | 0.25 | 456 hr |
| 8 | 0.03 g | 0.039 g | 0.039 g | 1:1 | 0.38 | 324 hr |

As shown in Table 1 and Table 2, pressure sensitive adhesives still exhibit peeling with one kind of silane coupling agent under conditions of high temperature and high humidity, but pressure sensitive adhesives with two different silane coupling agents, such as mixture of SA-1 and SA-2, having mixture ratio of about 1:1, shows no peeling at 85° C./90% RH for 500 hours.

Finally, while the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A pressure sensitive adhesive, comprising:
an acrylic adhesive;
a cross-linking agent; and
at least two different silane coupling agents.

2. The pressure sensitive adhesive as claimed in claim 1, passing 500 hours weatherability test at conditions of 85° C. and 90%.

3. The pressure sensitive adhesive as claimed in claim 1, coated on an optical film.

4. The pressure sensitive adhesive as claimed in claim 3, wherein the optical film comprises a polarizing film or a reflective film

5. The pressure sensitive adhesive as claimed in claim 1, wherein the acrylic adhesive is formed by polymerizing alkyl acrylate, alkoxide monomer and hydroxyl-containing monomer.

6. The pressure sensitive adhesive as claimed in claim 1, wherein the cross-linking agent comprises diisocyanate or epoxy resin.

7. The pressure sensitive adhesive as claimed in claim 1, wherein the diisocyanate comprises toluene-2,4-diisocyanate, toluene-2,6-diisocyanate, diphenyl methane-4,4′-diisocyanate or 1,6-hexamethylene diisocyanate.

8. The pressure sensitive adhesive as claimed in claim 1, wherein the two different silane coupling agents have a weight ratio of about 1:1 to 5:1.

9. The pressure sensitive adhesive as claimed in claim 1, wherein the cross-linking agent and the silane coupling agent have a weight ratio of about 0.1 to 0.4.

10. The pressure sensitive adhesive as claimed in claim 1, wherein the cross-linking agent and the silane coupling agent have a weight ratio of about 0.15 to 0.3.

11. The pressure sensitive adhesive as claimed in claim 1, wherein the cross-linking agent is present in an amount of about 0.01-0.2 parts by weight based on 100 parts by weight of the acrylic adhesive.

12. A method for improving weatherability of a pressure sensitive adhesive, comprising mixing an acrylic adhesive with a cross-linking agent and at least two different silane coupling agents uniformly.

13. The method for improving weatherability of a pressure sensitive adhesive as claimed in claim 12, wherein the acrylic adhesive is formed by polymerizing alkyl acrylate, alkoxide monomer and hydroxyl-containing monomer.

14. The method for improving weatherability of a pressure sensitive adhesive as claimed in claim 12, wherein the cross-linking agent comprises diisocyanate or epoxy resin.

15. The method for improving weatherability of a pressure sensitive adhesive as claimed in claim 12, wherein the diisocyanate comprises toluene-2,4-diisocyanate, toluene-2,6-diisocyanate, diphenyl methane-4,4′-diisocyanate or 1,6-hexamethylene diisocyanate.

16. The method for improving weatherability of a pressure sensitive adhesive as claimed in claim 12, wherein the two different silane coupling agents have a weight ratio of about 1:1 to 5:1.

17. The method for improving weatherability of a pressure sensitive adhesive as claimed in claim 12, wherein the cross-linking agent and the silane coupling agent have a weight ratio of about 0.1 to 0.4.

18. The method for improving weatherability of a pressure sensitive adhesive as claimed in claim 12, wherein the cross-linking agent and the silane coupling agent have a weight ratio of about 0.15 to 0.3.

19. The method for improving weatherability of a pressure sensitive adhesive as claimed in claim 12, wherein the cross-linking agent is present in an amount of about 0.01-0.2 parts by weight based on 100 parts by weight of the acrylic adhesive.
